(19) United States
(12) Patent Application Publication
(10) Pub. No.: US 2019/0101084 A1
(43) Pub. Date: Apr. 4, 2019

(54) AIR PIPE FOR AN INTAKE TRACT OF AN INTERNAL COMBUSTION ENGINE

(71) Applicant: Mahle International GmbH, Stuttgart (DE)

(72) Inventors: Martin Matt, Bruchsal (DE); Andrea Schuster, Altbach (DE); Michael Onischke, Obertuerkheim (DE); Vivak Luckhchoura, Duesseldorf (DE); Jan Schuessler, Koenigsbach-Stein (DE); Marco Cigarini, Stuttgart (DE)

(73) Assignee: Mahle International GmbH, Stuttgart (DE)

(21) Appl. No.: 15/537,414

(22) PCT Filed: Dec. 15, 2015
(86) PCT No.: PCT/EP2015/079735

§ 371 Date: May 14, 2018

(30) Foreign Application Priority Data
Dec. 19, 2014 (DE) DE102014019147.8

(51) Int. Cl. F02M 26/19; F02M 35/10; F02M 35/12; F04D 29/42; F04D 29/66

(52) U.S. Cl. CPC F02M 26/19; F02M 35/10157; F02M 35/10222; F02M 35/10262; F05B 2260/964; F02M 35/1272; F04D 29/4213; F04D 29/667; F05B 2250/501; F02M 35/1216

(57) ABSTRACT

An air pipe for an intake tract of an internal combustion engine may include at least one air channel for guiding a through-flow of air to at least one compressor arranged downstream thereof. An air guiding device may be arranged to influence a forward flow of air running in a direction towards the at least one compressor and facilitate reducing turbulences of the air flow.

### CROSS-REFERENCE TO RELATED APPLICATIONS

This application claims priority to German Patent Application No. 10 2014 019 147.8, filed on Dec. 19, 2014, and International Patent Application No. PCT/EP2015/079735, filed on Dec. 15, 2015, the contents of which are hereby incorporated by reference in their entirety.

### TECHNICAL FIELD

The invention relates to an air pipe for an intake tract of an internal combustion engine, in particular of a motor vehicle.

### BACKGROUND

Such air pipes for intake tracts of internal combustion engines, in particular for motor vehicles are already sufficiently known from the general prior art. Such an air pipe comprises at least one channel through which air can flow, by means of which air is guided or conducted to at least one compressor for compressing air which can be arranged downstream in the intake tract. In other words, in the completely manufactured state of the internal combustion engine, the air pipe is arranged in the intake tract. Furthermore, the compressor is arranged in the intake tract, this being arranged downstream of the air pipe in relation to the flow direction of the air through the air pipe. During operation thereof, the internal combustion engine sucks in air via the intake tract, wherein this air flows through the air pipe and is then compressed by means of the compressor so that efficient operation of the internal combustion engine is feasible. Such an air pipe can be deduced as known, for example from DE 10 2010 047 823 A1.

Internal combustion engines usually have a compact design in order to keep the space requirement of the internal combustion engines small. On account of this compact design, the air pipes, which are also designated as clean air pipes, are primarily constructed in the inflow area of the compressor with narrow radii. It has been shown that despite optimal design of the air pipe, particularly in the nominal load range of the internal combustion engine, flow-induced separations or turbulences can occur in the air pipe, which result in a reduction in the compressor efficiency. The consequence is that the fundamentally maximum possible nominal power of the internal combustion engine is not achieved.

### SUMMARY

It is therefore the object of the present invention to provide an air pipe of the type mentioned initially by means of which a particularly efficient operation of the compressor and therefore of the internal combustion engine as a whole can be achieved.

This object is solved by an air pipe having the features of the independent claim(s). Advantageous embodiments with expedient further developments of the invention are specified in the remaining claims.

In order to provide an air pipe of the type mentioned by means of which a particularly efficient operation of the compressor and therefore of the internal combustion engine overall can be achieved, it is provided according to the invention that the air pipe has an air guiding device by means of which a forward flow of air running in the direction of the compressor can be influenced whilst reducing turbulences of the air. In other words, the air guiding device is not configured for influencing a backward flow of air running away from the compressor but the air-guiding device is used to influence the forward flow of air running in the direction of the compressor. By means of the air-guiding device, in particular turbulence perturbations in an inflow area to the compressor and in particular to a compressor wheel can at least be kept small so that a particularly high efficiency of the compressor can be achieved particularly in nominal load operation of the internal combustion engine. In other words, by means of the air-guiding device it is possible, in particular in nominal load operation or in the case of nominal load, to keep separation and turbulences of the air flow in the air pipe, in particular in the area of its smallest radius, at least small or to prevent these so that a particularly advantageous pressure ratio can be achieved between a region upstream of the compressor and a region downstream of the compressor in the intake tract. In particular, it is possible to achieve a particularly advantageous inflow to the compressor blades of the compressor, which results in a particularly high pressure difference which in turn leads to a high efficiency of the compressor. In particular, an advantageous inflow to edge zones of the compressor blades can be achieved. Overall it is therefore possible to achieve a particularly high efficiency of the compressor and therefore a particularly high possible power of the internal combustion engine. It is preferably provided that the air guiding device comprises a plurality of guiding fins which project inwards from a wall of the air pipe which at least partially delimits the channel and which are spaced apart from one another in the circumferential direction of the air pipe in order to influence the forward flow running in the direction of the compressor. In this case, the number of guiding fins is preferably kept particularly small.

It has been shown to be particularly advantageous if the air guiding device has at most nine, preferably at most four guiding fins. By minimizing and optimally designing the guiding fins in particular in the inflow area to the compressor, a possible pressure loss disadvantage can at least be avoided or over-compensated compared to an ideal pipe guide without narrow radii. In particular by specific positioning of the guiding fins, separation effects and turbulences of the air flow which occur in the case of loading can at least be kept small or avoided so that a particularly high efficiency of the compressor can be achieved. At the same time, the air pipe can be configured with very narrow radii in order to keep the space requirement of the air pipe and therefore of the internal combustion engine with the intake tract overall particularly small. Since the number of guiding fins is kept particularly low, an excessive pressure loss can be avoided so that a particularly high power of the internal combustion engine can be achieved. In this case it is preferably provided that the guiding fins are distributed non-uniformly in the circumferential direction of the air pipe.

Expediently it can be provided that the guiding fins are arranged at an outlet end of the channel. In particular, it can be provided that the guiding fins are arranged exclusively at this outlet end.

In another embodiment, the channel can have a curve shape so that it has a curve inner side and a curve outer side. The guiding fins are then preferably distributed so that on a curve inner side of the channel they have a larger number and/or a shorter distance from one another in the circumferential direction than on a curve outer side of the channel. As a result, the deflecting effect of the curve shape can be compensated again by means of the guiding fins in the air flow.

Advantageous with regard to the flow resistance is a configuration in which the channel extends continuously from an inlet connection of the air pipe, through which air can enter into the channel, as far as an outlet connection of the air pipe through which air can emerge from the channel.

According to a particularly advantageous embodiment, the channel can be formed by a pipe body which is enclosed by a shell body of the air pipe in the circumferential direction, wherein an intermediate space is formed radially between pipe body and shell body. The pipe body can now have a perforation through which the channel is fluidically connected to the intermediate space. In the simplest case, a sound damper can be implemented by means of the perforation and the intermediate space. The intermediate space then forms an expansion chamber. If the intermediate space is additionally filled with a sound absorbing material, i.e. with an absorber material, the intermediate space can also form an absorption chamber.

Preferred however is a further development in which the intermediate space is used for distributed introduction of another gaseous fluid in the circumferential direction. The shell body then has a connection for introducing a gaseous fluid into the air, which is fluidically connected to the intermediate space so that the fluid can flow through the connection, through the intermediate space, through the perforation into the channel. As a result, a homogeneous admixing of fluid to the air flow can be achieved. The fluid, for example, comprises an exhaust gas which is supplied to the air as part of an exhaust gas return or blow-by gas which is supplied to the air as part of a crankcase ventilation. In particular, the air pipe can therefore be configured as a blow-by gas introducing device.

In another further development, the pipe body can lead from an inlet connection of the air pipe formed on the shell body to an outlet connection formed on the shell body. This also results in a reduced flow resistance.

An intake tract of an internal combustion engine which is suitable and intended for supplying air to the internal combustion engine comprises an air pipe of the type presented previously and a compressor to which the air pipe is connected on the outlet side. The inflow to the compressor can be improved with the aid of the air guiding device. The compressor is expediently part of an exhaust gas turbocharger. The intake tract can contain an air filter upstream of the air pipe.

Further important advantages, features and details of the invention are obtained from following description of preferred exemplary embodiments and with reference to the drawings. The features and feature combinations mentioned previously in the description and the features and feature combinations mentioned hereinafter in the description of the figures and/or shown in the figures alone can be used not only in the respectively given combination but also in other combinations or alone without departing from the scope of the present invention.

### BRIEF DESCRIPTION OF THE DRAWINGS

In the drawings:

FIG. 1 shows a schematic perspective view of an air pipe according to a first embodiment for an intake tract of an internal combustion engine, comprising at least one channel through which air can flow for guiding the air to at least one compressor which can be arranged in the intake tract downstream of the air pipe, for compressing the air, wherein the air pipe has an air guiding device by means of which a forward flow of air running in the direction of the compressor can be influenced whilst reducing turbulences of the air;

FIG. 2 shows in sections a schematic perspective view of the air pipe according to a second embodiment;

FIG. 3 shows in sections a schematic perspective view of the air pipe according to a third embodiment;

FIG. 4 shows in sections a schematic perspective view of the air pipe according to a fourth embodiment; and

FIG. 5 shows a circuit-diagram-like schematic diagram of an internal combustion engine with an intake tract in which such an air pipe is arranged.

In the figures the same or functionally the same elements are provided with the same reference numbers.

### DETAILED DESCRIPTION

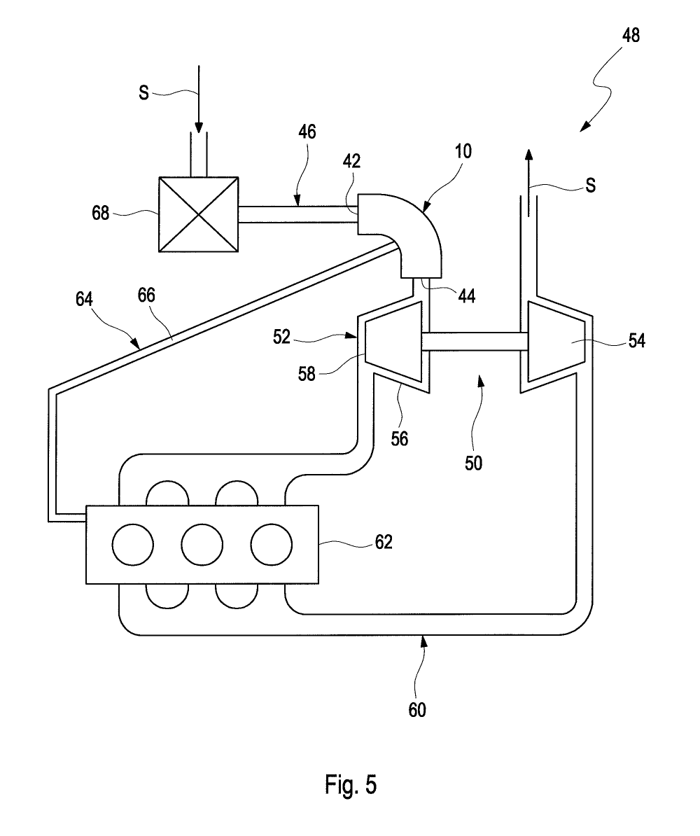

FIG. 1 shows in a schematic perspective view an air pipe designated overall by 10 according to a first embodiment for an intake tract, designated by 46 in FIG. 5, of an internal combustion engine which is designated by 48 in FIG. 5. During its operation the internal combustion engine 48 sucks in air via the intake tract 46 which air flows through the intake tract 46 and therefore the air pipe 10. The air pipe 10 is here also designated as clean air pipe. In the ready manufactured state of the internal combustion engine 48, a compressor 52 shown in FIG. 5 is arranged in the intake tract 46, wherein the compressor 52 is arranged downstream of the air pipe 10 in relation to a flow direction S of the air through the intake tract 46. This means that the air initially flows through the air pipe 10 and then through the compressor 52, so that the air is guided or conducted by means of the air pipe 10 to the compressor 52. For this purpose the air pipe 10 comprises a channel 12 through which air can flow, by means of which air is connected to the compressor 52.

In this case, the air pipe 10 has a connecting region 14 by means of which or in which the air pipe 10—in the ready manufactured state of the intake tract 46—is or can be fluidically connected to the compressor 52.

It can be seen from FIG. 1 that the air pipe 10 has a curved profile. For this purpose, the air pipe 10 is constructed with at least one radius. In order to keep the space requirement of the air pipe 10 and therefore of the intake tract 46 overall small, the radius is particularly small so that the air pipe 10 is highly curved. As a result of this curved configuration of the air pipe 10, the air is deflected or diverted by means of the air pipe 10 compared to a rectilinear flow of air. In this respect, the air pipe 10 here has a curved profile, wherein a curve inner side 28 and a curve outer side 30 are defined by the curve shape or curvature.

The compressor 52 according to FIG. 5 has a compressor housing 56 and a compressor wheel 58, which is arranged in the compressor housing 56 rotatably about an axis of rotation relative to the compressor housing 56. The compressor housing 56 has at least one air channel which in the ready manufactured state of the intake tract 46 is fluidically connected to the channel 12. As a result, the air flowing through the channel 12 can flow out from the channel 12 and into the channel of the compressor housing 56 so that the air is guided by means of the channel of the compressor housing 56 to the compressor wheel 58. The compressor wheel 58 has a plurality of compressor blades to which air flows. The air us thereby compressed by means of the compressor wheel 58.

The compressor 52 is a component of an exhaust gas turbocharger 50 which also comprises a turbine 54 arranged in an exhaust gas tract 60 of the internal combustion engine 48. The turbine 54 can be driven by exhaust gas of the internal combustion engine 48, wherein the compressor 52 can be driven by the turbine 54. As a result, energy contained in the exhaust gas can be used for compressing the air. Accordingly in FIG. 5 the intake tract 46 leads to an engine block 62 of the internal combustion engine 48 in which combustion chambers are located whilst the exhaust gas tract 60 leads away from the engine block 62.

In order to be able to achieve a particularly efficiency-favourable and therefore efficient operation of the compressor 5 and therefore of the exhaust gas turbocharger 50 as well as the internal combustion engine 48 overall. The air pipe 10 has an air guiding device 16 arranged upstream of the connecting region 14 in relation to the flow direction S of the air, by means of which a forward flow of the air running in the direction of the compressor can be influenced whilst reducing turbulences of the air in the air pipe 10. In other words, the air guiding device 16 is not used to influence a backward flow of the air running away from the compressor 52 but the said forward flow of the air is influenced by means of the air guiding device 16. The forward flow has the flow direction S with which the air flows through the air pipe 10 or the channel thereof 12.

In the first embodiment, the air guiding device 16 has precisely one continuous transverse fin 18, by means of which the forward flow of the air is influenced whereby a separation of the air from the air pipe 10 as well as undesired turbulence of the air can be at least reduced or kept small.

It can be seen from FIG. 1 that the transverse fin 18 extends continuously over a flow cross-section of the channel 12 through which the air can flow and therefore the air pipe 10. In this case the transverse fin 18 has a straight profile and extends, for example, through the central point of the preferably at least substantially circular flow cross-section so that the channel 12 is configured to be at least substantially circular at least in the area of the flow cross-section.

In the area of the flow cross-section, the channel 12 is delimited by a wall of the air pipe 10 wherein the wall for example is formed of a plastic. The transverse fin 18 extends continuously from one area of the wall to an opposite area of the wall, where it is preferably provided that the transverse fin 18 is formed in one piece with the wall and consequently is preferably made of a plastic.

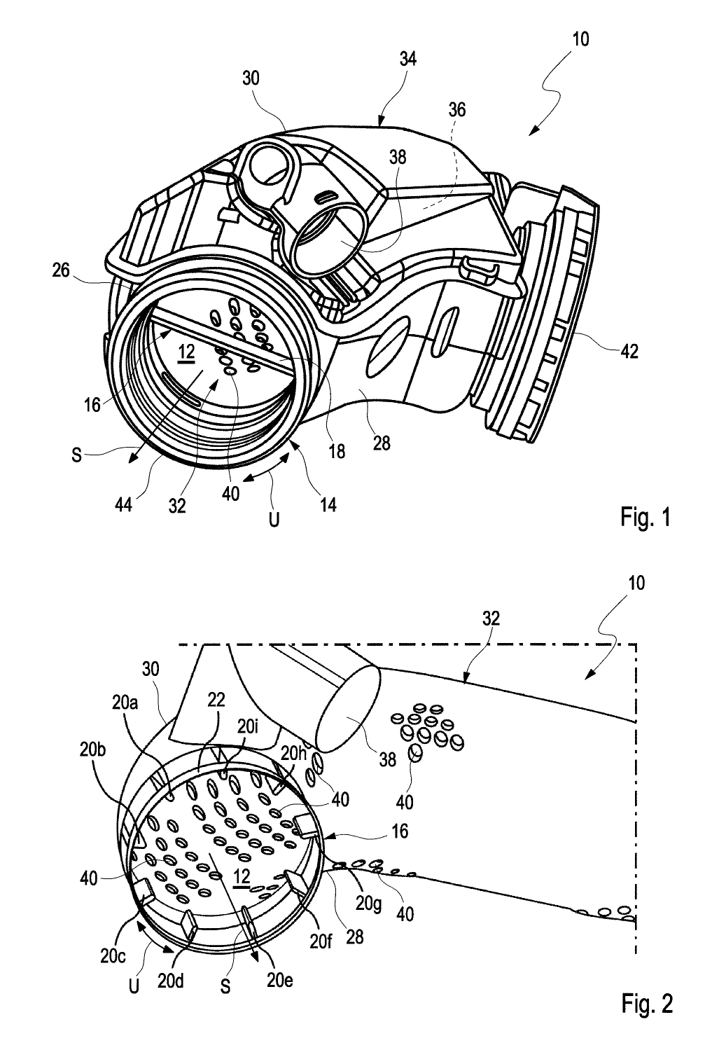

FIG. 2 shows a second embodiment of the air pipe 10. In the second embodiment the air guiding device 16 comprises a plurality of guiding fins 20a-i, which project inwards from the wall of the air pipe 10 which is designated by 22 in FIG. 2 and which at least partially delimits the channel 12. Here the guiding fins 20a-i project in the radial direction of the air pipe 10 or the channel 12 inwards from the wall 22 and are spaced apart from one another in the circumferential direction U of the air pipe 10. In order to keep the pressure loss brought about by the air guiding device 16 at least low, the number of guiding fins 20a-i is small.

In the second embodiment, the guiding fins 20a-i each have a width running in the circumferential direction U of the air pipe 10 of 2.5 millimetres, a height running in the radial direction of the air pipe 10 or the channel 12 of 5.75 millimetres and a length running in the flow direction S of the air or in the longitudinal extension direction of the air pipe 10 of 15 millimetres, wherein the length is also designated as depth of the guiding fins 20a-i. In the second embodiment, the guiding fins 20a-i therefore have a ratio of their width B to their height H of 2.5 to 5.75.

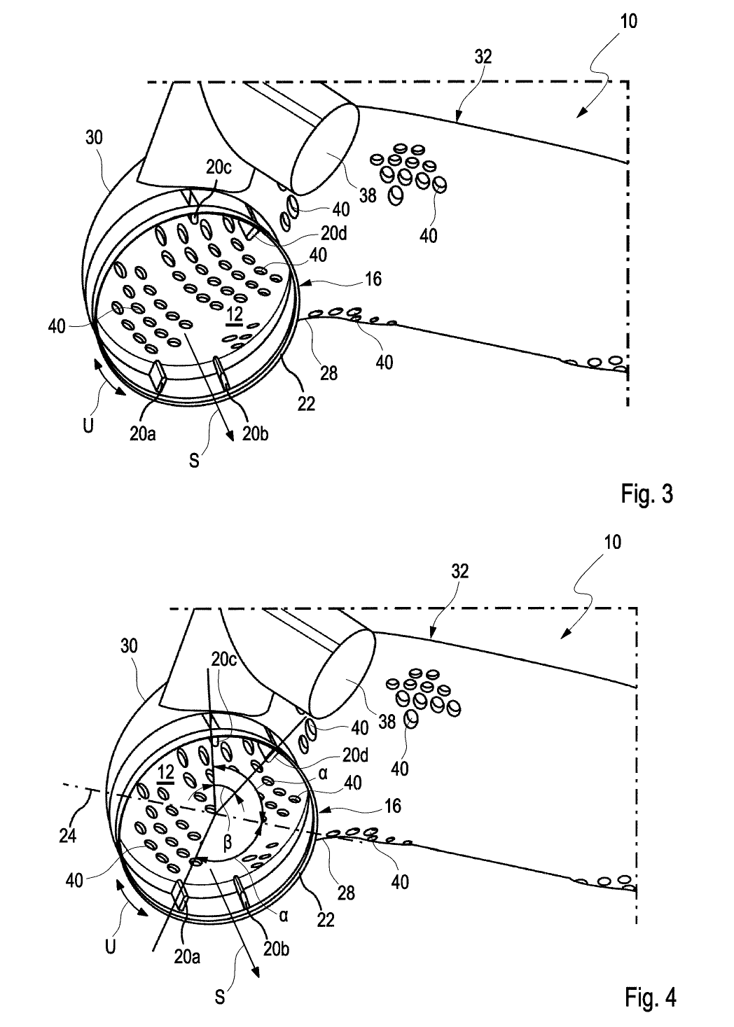

FIG. 3 shows a third embodiment of the air pipe 10 wherein the air guiding device 16 comprises precisely four guiding fins 20a-d which are, for example, non-uniformly distributed in the circumferential direction U of the air pipe 10. In the third embodiment it is preferably provided that the guiding fin 20a and the guiding fins 20c each have a width of 2.5 millimetres, a height of 10 millimetres and a length or depth of 15 millimetres. The guiding fins 20b and 20d preferably have a width of 2.5 millimetres, a height of 10 millimetres and a length or depth of 10 millimetres. This means that the guiding fins 20a-d of the third embodiment have a ratio of their width to their height of 0.25. It was surprisingly found that as a result, the forward flow of the air can be particularly advantageously influenced.

It has proved to be advantageous if the respective guiding fins 20a-d have a length or depth in a range of 10 millimetres inclusive to 50 millimetres inclusive, whereby the forward flow of the air can be particularly advantageously influenced with a depth or length of 15 millimetres.

FIG. 4 shows a fourth embodiment of the air pipe 10 which fundamentally corresponds to the third embodiment. FIG. 4 shows a central axis 24 of the narrowest inner radius of the air pipe 10. In relation to this central axis 24, the outer guiding fins 20a and 20c are spaced apart by at most 110 degrees. In other words, it is preferably provided that the outer guiding fins 20a and 20c enclose a respective angle α of at most 110 degrees with the central axis 24 of the narrowest inner radius of the air pipe 10.

Furthermore, the guiding fins 20a and 20b form the first guiding fin pair, wherein the guiding fins 20c and 20d form a second guiding fin pair. It is illustrated by reference to the guiding fins 20c and 20d that the respective guiding fins 20c and 20d or 20a and 20b of the respective guiding fin pair are spaced apart from one another by an angle β of 40 degrees. In other words the guiding fins 20a and 20b or 20c and 20d are spaced apart from one another by 40 degrees on the circular circumference of the air pipe 10 with the result that the forward flow of the air can be particularly advantageously influenced.

By means of the air guiding device 16, flow detachments with turbulences upstream of the compressor 52, in particular the compressor inlet, can be at least kept small or avoided. Furthermore, turbulences in the compressor 52 itself can be avoided or kept small so that a particularly efficient operation of the compressor 52 and the internal combustion engine 48 can be presented. In principle, the air pipe 10 can be configured with a particularly small radius, that is with a strong curvature in order to keep its space requirement small. Compared to the air pipe 10 without the guiding fins 20a-i or 20a-d, the guiding fins 20a-d result in a higher pressure loss upstream of the compressor 52 and in a higher pressure ratio and a higher efficiency. The charging pressure at the exit of the compressor 52 is therefore higher with simultaneous lower compressor power. Overall the compressor 52 can therefore be operated with a particularly high efficiency so that a particularly efficient and low-fuel-consumption operation of the internal combustion engine 48 can be achieved.

If the air pipe 10 as here has a curve shape, the guiding fins 20a-i are preferably distributed in the circumferential direction U so that on the curve inner side 28 a larger number of guiding fins 20a-i are arranged than on the curve outer side 30. Additionally or alternatively it can also be provided that the guiding fins 20a-i are arranged on the curve inner side 28 with a higher density, i.e. with shorter distance from one another in the circumferential direction U than on the curve outer side 30. In particular, an embodiment is also feasible in which these guiding fins 20a-i are only arranged on the curve inner side 28.

Furthermore, it is expediently provided that the guiding fins 20a-i are preferably or exclusively arranged at an outlet end 26 of the air pipe 10.

As can be seen in a combined view of FIGS. 1 to 4, according to a particularly advantageous embodiment it can be provided that the channel 12 is formed by a pipe body 32 which is enclosed by a shell body 34 of the air pipe 10 in the circumferential direction U. This is accomplished so that an intermediate space 36 is formed radially between pipe body 32 and shell body 34. The pipe body 32 is additionally fitted with a perforation 40 by means of which the channel 12 is fluidically connected to the intermediate space 36.

Expediently the pipe body 32 leads from an inlet connection 42 of the air pipe 10 formed on the shell body 34 to an outlet connection 44 formed on the shell body 34. This also results in a reduced flow resistance.

In the example shown, it is further provided that the intermediate space 36 is used for the distributed introduction of another gaseous fluid in the circumferential direction U. Accordingly, the shell body 34 has a connection 38 for introducing a gaseous fluid into the air which is fluidically connected to the intermediate space 36 so that the fluid can flow in through the connection 38, through the intermediate space 36, through the perforation 40 into the pipe body 32 or into the channel 12. As a result, a homogenous mixing of the fluid with the air flow can be achieved. The fluid is, for example, an exhaust gas which is supplied to the air as part of an exhaust gas return, or blow-by gas which is supplied to the air as part of a crankcase ventilation. Such a crankcase ventilation is shown in the example of FIG. 5 and designated by 64. A blow-by gas pipe 66 clearly leads to the air pipe 10. In particular, the air pipe 10 can thus be configured as a blow-by gas introducing device. The crankcase ventilation 64 additionally has an oil mist separation not shown here.

The intake tract 46 of the internal combustion engine 48 which is suitable and intended for supplying air to the internal combustion engine 48 contains the air pipe 10 and the compressor 52 to which the air pipe 10 is connected on the outlet side. The intake tract 46 contains an air filter 68 upstream of the air pipe 10.

1. An air pipe for an intake tract of an internal combustion engine, comprising:
at least one channel for guiding a through-flow of air to at least one compressor for compressing air arranged downstream thereof; and
an air guiding device arranged to influence a forward flow of air running in a direction towards the at least one compressor and facilitate reducing turbulences of the forward flow of air.

2. The air pipe according to claim 1, wherein the air guiding device includes a plurality of guiding fins projecting inwards from a wall at least partially defining the at least one channel, the plurality of guiding fins arranged spaced apart from one another along the wall in a circumferential direction of the at least one channel.

3. The air pipe according to claim 2, wherein the plurality of guiding fins has at most nine guiding fins.

4. The air pipe according to claim 2, wherein at least two of the plurality of guiding fins are spaced apart from one another by 40 degrees in the circumferential direction.

5. The air pipe according to claim 2, wherein at least one of the plurality of guiding fins is spaced apart from a central axis defined in a narrowest inner radius of the at least one channel by 110 degrees or less.

6. The air pipe according to claim 2, wherein the plurality of guiding fins have a respective width running in the circumferential direction and a respective height running in a radial direction of the at least one channel, wherein a ratio of the respective width to the respective height of the plurality of guiding fins is 0.25.

7. The air pipe according to claim 2, wherein the plurality of guiding fins have a length of 15 millimetres or less running in an air flow direction.

8. The air pipe according to claim 2, wherein the plurality of guiding fins are arranged at an outlet end of the at least one channel.

9. The air pipe according to claim 2, wherein the at least one channel has a curved shape; and
wherein a first set of the plurality of guiding fins are disposed on a curve inner side of the at least one channel and have at least one of a larger number and a shorter distance from one another in the circumferential direction than a second set of the plurality of guiding fins disposed on a curve outer side of the at least one channel.

10. The air pipe according to claim 1, wherein the at least one channel extends continuously from an inlet connection to an outlet connection.

11. The air pipe according to claim 1, further comprising a pipe body and a shell body, wherein:
the at least one channel is defined by the pipe body, the pipe body enclosed by the shell body in a circumferential direction of the at least one channel;
an intermediate space is provided radially between pipe body and shell body; and
the pipe body has a perforation fluidically connecting the at least one channel to the intermediate space.

12. The air pipe according to claim 11, wherein the shell body includes a connection for introducing a gaseous fluid into the through-flow of air, and wherein the connection is connected fluidically to the intermediate space to permit the gaseous fluid introduced through the connection to flow into the at least one channel via the intermediate space and the perforation.

13. The air pipe according to claim 12, wherein the pipe body is configured to introduce a blow-by-gas to the at least one compressor.

14. The air pipe according to claim 11, wherein the pipe body leads from an inlet connection disposed on the shell body to an outlet connection disposed on the shell body.

15. An intake tract of for supplying air to an internal combustion engine, comprising:
an air pipe;
a compressor fluidly connected to an outlet side of the air pipe;
the air pipe including:
at least one channel for guiding a through-flow of air to the compressor arranged downstream of the air pipe; and
an air guiding device arranged to influence a forward flow of air running in a direction towards the compressor and facilitate reducing turbulences of the forward flow of air.

16. The intake tract according to claim 15, wherein the air pipe includes a wall defining at least part of the channel; and
wherein the air guiding device includes a plurality of guiding fins projecting inwards from the wall, the plurality of guiding fins arranged spaced apart from one another along the wall in a circumferential direction of the air pipe.

17. The intake tract according to claim 16, wherein at least two of the plurality of guiding fins are spaced apart from one another along the wall by 40 degrees in the circumferential direction.

18. The intake tract according to claim 16, wherein at least one guiding fin of the plurality of guiding fins has a ratio of a width of the at least one guiding fin running in the circumferential direction to a height of the at least one guiding fin running in a radial direction of the air pipe of 0.25.

19. The intake tract according to claim 15, wherein the air pipe is configured as a blow-by-gas introducing device.

20. An air pipe for an intake tract of an internal combustion engine, comprising:
a pipe body defining at least one channel for guiding a through-flow of air to an air compressor arranged downstream thereof, the pipe body including a wall at least partially defining the at least one channel;
an air guiding device arranged to influence a forward flow of air running in a direction towards the compressor and facilitate reducing turbulences of the forward flow of air, the air guiding device including a plurality of guiding fins projecting inwards from the wall; and
wherein the plurality of guiding fins are arranged spaced apart from one another along the wall in a circumferential direction of the pipe body.
